(19) United States
(12) Patent Application Publication
(10) Pub. No.: US 2023/0400087 A1
(43) Pub. Date: Dec. 14, 2023

(54) Electric Mechanical Piston Engine

(71) Applicant: Eric Brown, Bridgwater, MA (US)

(72) Inventor: Eric Brown, Bridgwater, MA (US)

(21) Appl. No.: 17/803,383

(22) Filed: Jun. 13, 2022

(51) Int. Cl. F16H 37/12

(52) U.S. Cl. CPC F16H 37/12

(57) ABSTRACT

What is new within this engine in the field of the magnetic engine is that it uses the cylinder chains as the catalyst to make the engine work, by this we mean that the cylinder chains are the workhorse of the engine being that it moves to push down the pistons to turn the crankshaft.

### BACKGROUND OF THE INVENTION

Pertaining to the background of the invention this is an invention that will be used in the field of power generation, or better yet used in a power plant to generate electricity. In essence this is a magnetic engine.

Although I receive most of my information from the Encyclopedia Americana and the McGraw Hill Encyclopedia of science and technology, there really is no source of information that is written about this engine or related matter because there is nothing out there in public that is currently like it, except my other engine the Electro Mechanical Piston Engine which operates differently than this engine yet some things are similar, such as the power source that delivers energy to the cylinders.

### BRIEF SUMMARY OF THE INVENTION

But as far as the engines of today that use fuel to power them, my engine is different because it uses the power of the generator along with a gearing system to create force which powers the pistons to push the crank to reciprocate. With that said the object of the engine is to replace fossil fuel engines. And because other mechanical engines use fuel to operate this makes my engine more desirable because of no need for fuel.

### BRIEF DESCRIPTION OF THE DRAWINGS

There are three drawings being submitted and they are numbered as FIG. 1a, FIG. 2b, and FIG. 3c. In FIG. 1a is shown the side view with 3 cylinders showing of a 6 cylinder engine block, but what must be kept in mind is that only 3 cylinders are shown to show the inside of each cylinder within the main focus.

FIG. 2b is just one cylinder shown with larger view of the inside of the cylinder.

Inside FIG. 2b is shown the generator, connecting gears that control the cylinder chains, top cylinder piston with top piston rods, bottom piston and piston rod and crankshaft.

FIG. 3c is the power controller, this is where the cylinder generators gets its power to work, inside it are the generators, transformers and gear shafts that make the generators spin, also is the power controller control bubs that decide where energy is sent to each cylinder.

### DETAILED DESCRIPTION OF INVENTION

What will be explained first is the interaction within the engine to observe how we obtain power.

The electricity comes down from the power controller to the cylinder generator 02 which causes the connecting gears 03 which is connected to the piston pusher lever 05 through the cylinder chains 04 to move downward, pushing the top cylinder piston 06 which pushes the bottom piston 08, thereby pushing down on the crank 10 thereby creating a centrifical force.

Because the cylinder chains is what is used to push the pistons down by way of the generator to create force is what sets it apart from other engines. The improvement that is achieved here is we get the downward motion from the cylinder chains which causes a centrifical force on the crankshaft.

The engine block can essentially be constructed of aluminum or be of a ceramic composition thereby limiting the affects of magnetism through-out the engine block.

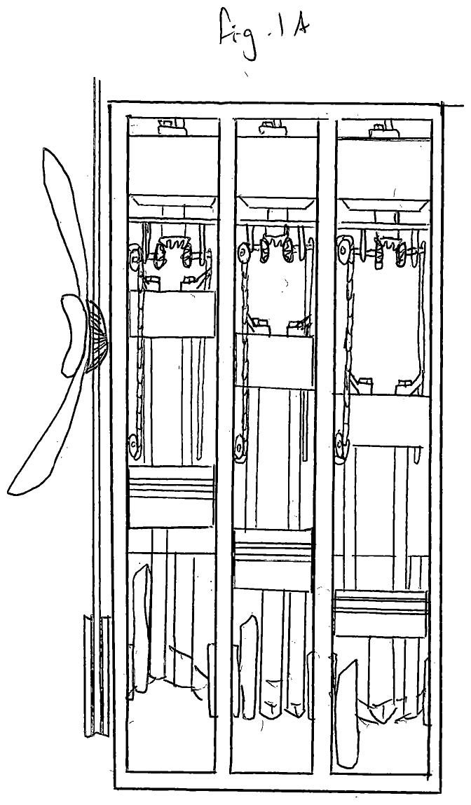

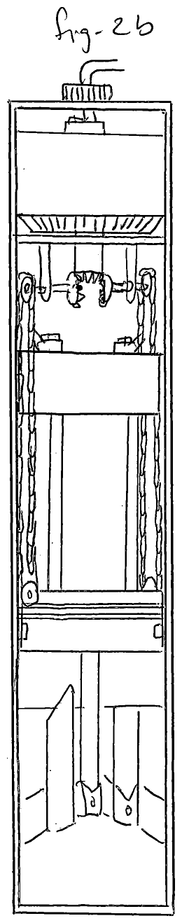

This is a notice to let the reader know that all the numbers of FIG. 1a and FIG. 2b are all the same because they depict the apparatus's within the machine. FIG. 2b is just an expanded view of FIG. 1a.

Here are the numbers matched up with the name of each part within the engine.
01 wire leading to power controller
02 cylinder generator
03 connecting gears
04 cylinder chains
05 piston push lever
06 Cylinder piston
07 top piston rod
08 bottom piston
09 bottom piston rod
10 crankshaft

The top numbers and parts are for FIG. 1a and FIG. 2b.

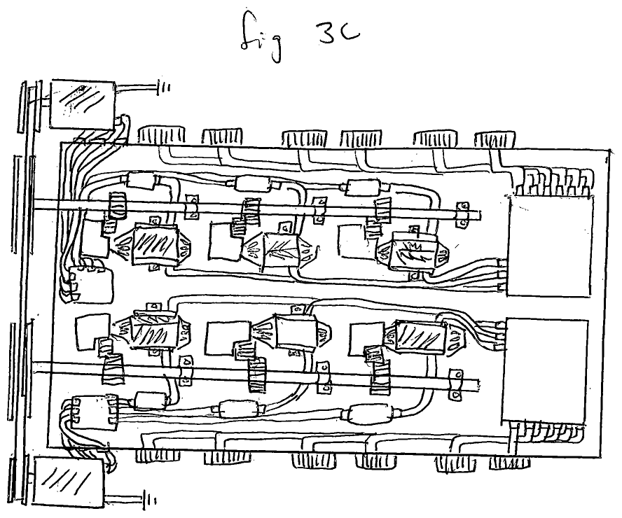

This is another explanation of numbers corresponding with the part of FIG. 3c parts within the apparatus.

Here are the numbers matched up with the name of each part within the engine. These are all the parts within the FIG. 3c.
14 the transformer
15 the generators
16 the generator cable hub
17 the power distributor
18 the main feed generators

### CONTINUATION OF BRIEF SUMMARY OF INVENTION

One thing that must be noted is that in FIG. 1a and FIG. 2b the cylinder chains that are drawn are shown to be in the cylinder itself, when in truth the cylinder chains are behind the cylinder walls.

What also must be noted is that from all the generators around the engine they give back power to the batteries, this is done all the while the engine is running. So while the batteries are giving power to the cylinder generators the surrounding generators are giving power back to the batteries.

1. I claim that this magnetic engine works differently from all other magnetic engines; the fact that it uses the cylinder chains as the catalyst to push the bottom piston down to turn the crank is what makes it different from all other magnetic engines.
